(19) United States
(12) Patent Application Publication
(10) Pub. No.: US 2021/0129635 A1
(43) Pub. Date: May 6, 2021

(54) Sun Visor Apparatus for Vehicle and Method for Controlling the Same

(71) Applicants: Hyundai Motor Company, Seoul (KR); Kia Motors Corporation, Seoul (KR)

(72) Inventors: Jong Sung Park, Seoul (KR); Dae Sun Park, Incheon (KR); Yang Ho Ryu, Yongin-si (KR)

(21) Appl. No.: 16/849,211

(22) Filed: Apr. 15, 2020

(30) Foreign Application Priority Data
Oct. 30, 2019 (KR) 10-2019-0136691

(51) Int. Cl. B60J 3/02; B60R 11/04; B60R 11/02; G05D 1/00; G06F 3/14; H04N 5/57; H04N 5/445

(52) U.S. Cl. CPC B60J 3/0278; B60R 11/04; B60R 11/0235; B60R 2011/0035; G06F 3/1446; H04N 5/57; H04N 5/445; G05D 1/0088

(57) ABSTRACT

A sun visor apparatus for a vehicle includes a light shield with a plurality of coupled display panels. A driver is configured to drive the display panels of the light shield such that the display panels are folded or unfolded. A controller is configured to control the light shield and the driver. The controller is configured to receive a user input, to control the driver to fold or unfold the display panels such that the display panels execute a predetermined function of the light shield, and to control the light shield to display, on the display panels, image information corresponding to the predetermined function of the light shield according to the received user input.

### CROSS-REFERENCE TO RELATED APPLICATION

This application claims priority to Korean Patent Application No. 10-2019-0136691, filed on Oct. 30, 2019, which application is hereby incorporated herein by reference.

### TECHNICAL FIELD

The present invention relates to a sun visor apparatus for a vehicle.

### BACKGROUND

Generally, light incident upon the interior of a vehicle through a windshield or window of the vehicle during driving of the vehicle may dazzle the eyes of the driver, thereby degrading visibility of the driver. In this case, safe driving of the driver may be disturbed. Furthermore, the incident light may be reflected on a display device installed in the vehicle, thereby degrading readability of the display device.

In this case, the driver may shield light incident upon the interior of the vehicle by manually manipulating a sun visor installed in the vehicle.

However, when the driver manipulates the sun visor during driving, there may be a problem in that safe driving may be disturbed.

Meanwhile, a single display may be installed at a center fascia in a vehicle. In connection with this, a display having a larger screen may be needed because information that can be displayed through the display becomes more diverse, and input of information is enabled through touching of the display.

To this end, development of a sun visor apparatus for a vehicle capable of not only having a sunlight shielding function, but also achieving a display function realizing a large screen is desired.

### SUMMARY

The present invention relates to a sun visor apparatus for a vehicle. Particular embodiments relate to a sun visor apparatus for a vehicle capable of providing various convenience functions through application of a foldable display and a method for controlling the same.

Particular embodiments are directed to a sun visor apparatus for a vehicle and a method for controlling the same that substantially obviate one or more problems due to limitations and disadvantages of the related art.

Embodiments of the present invention provide a sun visor apparatus for a vehicle and a method for controlling the same, which can provide various conveniences to the driver through application of a foldable display capable of realizing a large screen to a sun visor only having a sun visor function.

Other embodiments of the present invention provide a sun visor apparatus for a vehicle and a method for controlling the same, which can achieve multiple functions including a lighting function, a mirror function, a large display function, etc. in accordance with a position of a sun visor and whether or not the sun visor is folded.

Further embodiments of the present invention provide a sun visor apparatus for a vehicle and a method for controlling the same, which is capable of providing a large-screen display suitable for a user's needs associated with increased utilization of content according to commercialization of an autonomous vehicle in the future while maximizing utility of packages in a limited indoor compartment of the vehicle.

Additional advantages, objects, and features of the embodiments will be set forth in part in the description which follows and in part will become apparent to those having ordinary skill in the art upon examination of the following or may be learned from practice of the embodiments. The objectives and other advantages of the embodiments may be realized and attained by the structure particularly pointed out in the written description and claims hereof as well as the appended drawings.

According to an embodiment of the present disclosure, a sun visor apparatus for a vehicle includes a light shield, at which a plurality of coupled display panels is disposed. The sun visor apparatus further includes a driver configured to drive the display panels of the light shield such that the display panels are folded or unfolded. The sun visor apparatus also includes controller configured to control the light shield and the driver, wherein, upon receiving user input, the controller controls the driver to fold or unfold the display panels such that the display panels execute a predetermined function of the light shield, while controlling the light shield to display, on the display panels, image information corresponding to the predetermined function of the light shield.

In another embodiment of the present invention, a method for controlling a sun visor apparatus for a vehicle including a light shield including a plurality of display panels, a driver configured to drive the display panels, for folding or unfolding of the display panels, and a controller configured to control the light shield and the driver includes checking, by the controller, whether or not user input is received. The method further includes identifying, by the controller, a function of the light shield requested to be executed in accordance with the user input when the user input is received. The method also includes controlling, by the controller, the driver to fold or unfold the display panels in accordance with the function of the light shield requested to be executed, and controlling, by the controller, the light shield to display, on the display panels, image information corresponding to the function of the light shield requested to be executed.

In another embodiment of the present invention, a computer-readable recording medium, on which a program for executing the method for controlling the sun visor apparatus for the vehicle is written, executes a procedure provided in the control method.

In still another embodiment of the present invention, a vehicle includes an input unit configured to receive user input, and a sun visor apparatus including a plurality of display panels, the sun visor apparatus configured to fold or unfold the display panels in accordance with the user input, to execute a predetermined function. The sun visor apparatus further includes a light shield, at which the plurality of display panels is disposed in a coupled state, a driver configured to drive the display panels of the light shield such that the display panels are folded or unfolded, and a controller configured to control the light shield and the driver, the controller configured to control the driver to fold or unfold the display panels such that the display panels execute a predetermined function of the light shield, while configured to control the light shield to display, on the display panels, image information corresponding to the predetermined function of the light shield, upon receiving the user input.

In accordance with the sun visor apparatus configured in accordance with at least one of the above embodiments of the present invention and the control method thereof, it may be possible to provide various conveniences to the driver through application of a foldable display capable of realizing a large screen to a sun visor only having a sun visor function.

In addition, embodiments of the present invention may achieve realization of multiple functions such as a lighting function, a mirror function, a large display function, etc. in accordance with a position of the sun visor and whether or not the sun visor is folded.

Furthermore, embodiments of the present invention may provide a large-screen display suitable for a user's needs associated with increased utilization of content according to commercialization of an autonomous vehicle in the future while maximizing utility of packages in a limited indoor compartment of the vehicle.

That is, embodiments of the present invention may provide a sun visor apparatus capable of executing existing functions such as a front monitor function and a head-up display (HUD) function in accordance with functions thereof associated with utilization of in-vehicle packages and, as such, associated items occupying a large physical space may be omitted.

In addition, embodiments of the present invention may secure an increased number of functions and increased utility, as compared to conventional physical sun visors. Furthermore, it may be possible to support various modes in accordance with various display folding shapes given at various angles of the sun visor.

In addition, embodiments of the present invention may provide a sun visor apparatus of a convergence and integration type and, as such, a reduction in cost of the vehicle may be achieved.

The effects of embodiments of the present invention are not limited to the above-described effects and other effects which are not described herein may be derived by those skilled in the art from the following description of the embodiments of the present invention.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and along with the description serve to explain the principle of embodiment(s) of the invention. In the drawings:

FIG. 1 is a block diagram explaining a sun visor apparatus for a vehicle according to an embodiment of the present invention;

FIG. 2 is a view illustrating the sun visor apparatus mounted in the vehicle;

FIG. 3 is a view showing a folded state of a light shield;

FIG. 4 is a view showing an unfolded state of the light shield;

FIG. 5 is a view showing an unfolding procedure of the light shield in the sun visor apparatus;

FIG. 6, which includes FIGS. 6A and 6B, is a view explaining the sun visor apparatus when the sun visor apparatus executes a lighting function;

FIG. 7, which includes FIGS. 7A and 7B, is a view explaining the sun visor apparatus when the sun visor apparatus executes a mirror function;

FIG. 8, which includes FIGS. 8A and 8B, is a view explaining the sun visor apparatus when the sun visor apparatus executes a large-screen display function;

FIG. 9, which includes FIGS. 9A and 9B, is a view explaining the sun visor apparatus when the sun visor apparatus executes a large-screen display function including an information display window;

FIGS. 10A and 10B are views illustrating use examples of the sun visor apparatus executing a large-screen display function including an information display window, respectively; and

FIG. 11 is a flowchart explaining a method for controlling a sun visor apparatus for a vehicle in accordance with an embodiment of the present invention.

### DETAILED DESCRIPTION OF ILLUSTRATIVE EMBODIMENTS

Hereinafter, preferred embodiments of the present invention will be described in detail with reference to the accompanying drawings and, as such, may be easily implemented by one of ordinary skill in the art to which the present invention pertains. The present invention may be embodied in many different forms and should not be construed as limited to the embodiments set forth herein. Matters having no concern with the invention will be omitted, for clarity of explanation. The same or similar elements throughout the specification are designated by the same reference numerals.

It will be understood that the terms “comprises” and/or “comprising,” or “includes” and/or “including” when used in the specification, specify the presence of stated matters, but do not preclude the presence or addition of one or more other matters. In addition, terms such as “unit”, “module”, and the like used herein indicate a unit for performing at least one function or operation and may be implemented by hardware or software or a combination thereof.

The terms “including”, “comprising”, “having” and variations thereof disclosed herein mean “including but not limited to” unless expressly specified otherwise, and, as such, should not be construed as excluding elements other than the elements disclosed herein and should be construed as further including additional elements. Elements designated by the same reference numerals throughout the specification refer to the same constituent elements.

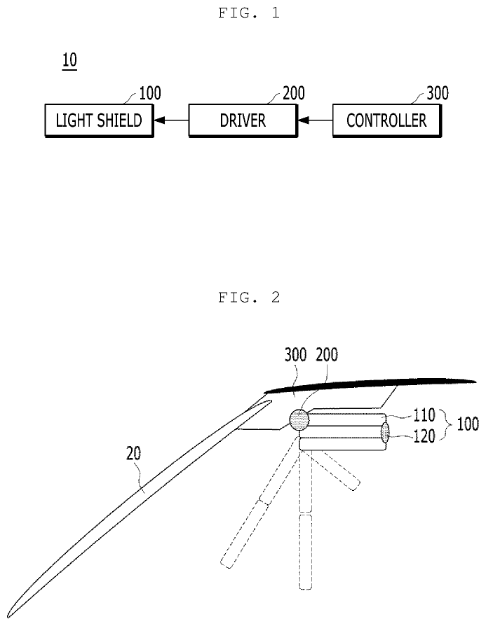

Hereinafter, a sun visor apparatus for a vehicle and a method for controlling the same, which are applicable to embodiments of the present invention, will be described with reference to FIGS. 1 to 11.

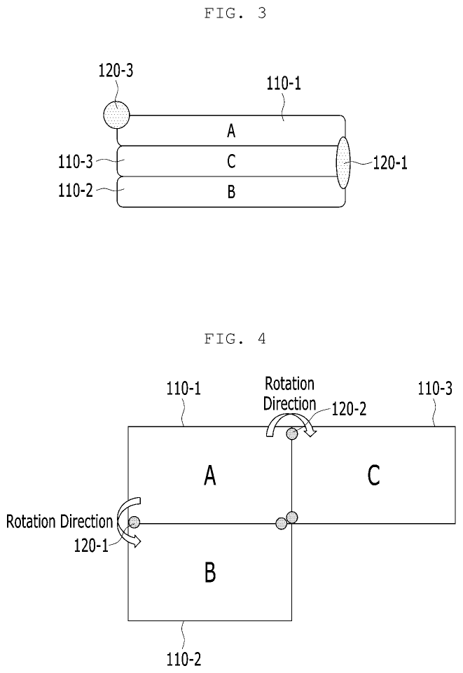

FIG. 1 is a block diagram explaining a sun visor apparatus for a vehicle according to an embodiment of the present invention. FIG. 2 is a view illustrating the sun visor apparatus mounted in the vehicle.

As shown in FIGS. 1 and 2, the vehicle may include an input unit configured to receive user input, and a sun visor apparatus lo configured to execute a predetermined function by folding or unfolding display panels 110 in accordance with the user input.

The sun visor apparatus 10 may be disposed at an upper portion of a windshield 20 within an interior of the vehicle.

The sun visor apparatus 10 may include a light shield 100, at which a plurality of coupled display panels 110 is disposed, a driver 200 configured to drive the display panels 110 of the light shield 100 such that the display panels 110 are folded or unfolded, and a controller 300 configured to control the light shield 100 and the driver 200.

In this case, the light shield wo may include the plurality of display panels 110, and a fastener 120 disposed at a boundary between adjacent ones of the display panels 110, to fasten the display panel 110, and configured to rotate the display panels 110 about the boundary in accordance with a drive signal from the driver 200.

For example, each of the display panels 110 may include at least one of a liquid crystal display (LCD), a thin film transistor-liquid crystal display (TFT LCD), an organic light-emitting diode (OLED), a plastic organic light-emitting diode (POLED), a flexible display, a 3-dimensional display (3D display), or an electronic-ink (e-ink) display.

For example, the fastener 120 may include a hinge for connecting and rotating the adjacent display panels 110.

In addition, the display panels 110 of the light shield 100 may have screen sizes having the same area.

If necessary, the display panels 110 of the light shield 100 may have screen sizes having different areas, respectively.

In addition, the plural display panels 110 may be sequentially stacked in a direction perpendicular to a display screen when folded. When unfolded, the plural display panels 110 may be arranged in one of a longitudinal direction and a transversal direction.

In this case, when folded, the plural display panels 110 may be arranged such that screens of two display panels 110, which are disposed at outermost positions, respectively, may be directed in opposite directions. When unfolded, the two display panels 110 respectively disposed at the outermost positions may be arranged such that the screens thereof are directed in the same direction.

Meanwhile, the light shield 100 may be disposed at the upper portion of the windshield 20 within the interior of the vehicle. The light shield 100 may rotate toward the windshield 20 in accordance with a drive signal from the driver 200.

Upon receiving user input, the controller 300 may control the driver 200 to fold or unfold the display panels 110 in order to execute a predetermined function of the light shield 100. The controller 300 may also control the light shield 100 to display, on the display panels 110, image information corresponding to the predetermined function of the light shield 100.

For example, when the user input is a request for a lighting function, the controller 300 may control the driver 200 to fold the display panels 110 of the light shield 100 such that the display panels 110 rotate in a predetermined direction through a predetermined angle. In this case, the controller 300 may also control the light shield 100 to adjust screen brightness of the display panel 110 disposed at an outermost position of the light shield 100.

In another example, when the user input is a request for a mirror function, the controller 300 may control the driver 200 to fold the display panels 110 of the light shield 100 such that the display panels 110 rotate in a predetermined direction through a predetermined angle. In this case, the controller 300 may also control the light shield 100 to display an indoor image acquired from an in-vehicle camera on the screen of the display panel 110 disposed at an outermost position of the light shield 100.

In another example, when the user input is a request for a large-screen display function, the controller 300 may control the driver 200 to unfold the display panels 110 of the light shield 100. In this case, the controller 300 may also control the light shield 100 to display an image and content information on screens of the unfolded display panels 110.

In another example, when the user input is a request for a large-screen display function including an information display window, the controller 300 may control the driver 200 to unfold all of the display panels 110 of the light shield 100. In this case, the controller 300 may also control the light shield 100 to display additional information on the screens of a part of the unfolded display panels 110 while displaying an image and content information on the screens of the remaining part of the unfolded display panels 110.

Thus, an embodiment of the present invention is adapted to provide a large-screen display suitable for a user's needs associated with increased utilization of content according to commercialization of an autonomous vehicle in the future while maximizing utility of packages in a limited indoor compartment of the vehicle.

In addition, an embodiment of the present invention may provide various convenient functions to the user through application of a foldable display to a sun visor only having a sunlight shielding function in conventional cases.

Furthermore, embodiments of the present invention may achieve realization of multiple functions such as a lighting function, a mirror function and a large display in accordance with a position of the sun visor and whether or not the sun visor is folded.

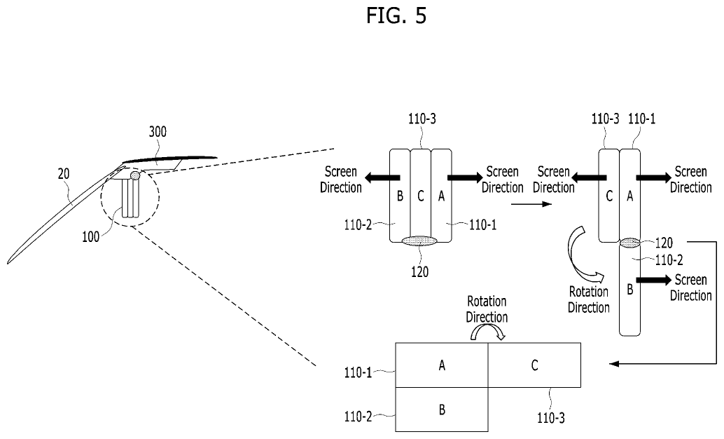

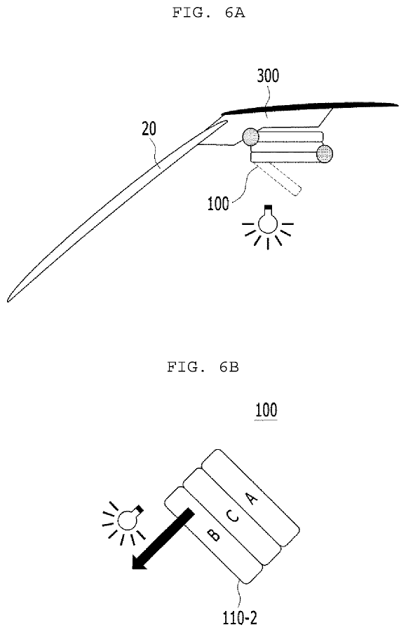

FIG. 3 is a view showing a folded state of the light shield. FIG. 4 is a view showing an unfolded state of the light shield. FIG. 5 is a view showing an unfolding procedure of the light shield in the sun visor apparatus.

The light shield 100 may include a plurality of display panels 110, and fasteners 120 configured to rotatably fasten the display panels 110. Hereinafter, an unfolding procedure of the light shield 100 will be described with reference to FIGS. 3 to 5 when the light shield 100 includes three display panels 110.

As illustrated in FIGS. 3 to 5, the light shield 100 may include first, second and third display panels 110-1, 110-2 and 110-3, and first, second and third fasteners 120-1, 120-2 and 120-3.

In this case, the first fastener 120-1 is connected to a lower side of the first display panel 110-1 and an upper side of the second display panel 110-2 such that the first fastener 120-1 rotates the second display panel 110-2 with respect to an X-axis.

In addition, the second fastener 120-2 is connected to a right side of the first display panel 110-1 and a left side of the third display panel 110-3 such that the second fastener 120-2 rotates the third display panel 110-3 with respect to a Y-axis.

Meanwhile, the third fastener 120-3 is connected to an upper side of the first display panel 110-1 and an upper fixed portion of the windshield 20 within the interior of the vehicle such that the third fastener 120-3 rotates the first display panel 110-1 with respect to the X-axis.

In addition, the first, second and third display panels 110-1, 110-2 and 110-3 may have screen sizes having the same area, respectively.

If necessary, the first, second and third display panels 110-1, 110-2 and 110-3 may have screen sizes having different areas, respectively.

In addition, folding of the first, second and third display panels 110-1, 110-2 and 110-3 may be achieved through rotation of the third display panel 110-3 with respect to the Y-axis toward a back surface of the first display panel 110-1, rotation of the second display panel 110-2 with respect to the X-axis toward the back surface of the first display panel 110-1, and rotation of the first display panel 110-1 with respect to the X-axis toward the upper fixed portion of the windshield 20 within the vehicle.

In this case, when the third display panel 110-3 is folded, the screen of the third display panel 110-3 may be disposed to be directed in a direction opposite to a screen direction of the first display panel 110-1. When the second display panel 110-2 is folded, the screen of the second display panel 110-2 may be disposed to be directed in the direction opposite to the screen direction of the first display panel 110-1 while being directed in the same direction as a screen direction of the third display panel 110-3.

On the other hand, unfolding of the first, second and third display panels 110-1, 110-2 and 110-3 may be achieved through rotation of the first display panel 110-1 with respect to the X-axis toward the windshield 20 within the vehicle, rotation of the second display panel 110-2 with respect to the X-axis in a downward direction of the first display panel 110-1, and rotation of the third display panel 110-3 with respect to the Y-axis in a right direction of the first display panel 110-1.

In this case, when the third display panel 110-3 is unfolded, the screen of the third display panel 110-3 may be disposed to be directed in the same direction as the screen direction of the first display panel 110-1. When the second display panel 110-2 is unfolded, the screen of the second display panel 110-2 may be disposed to be directed in the same direction as the screen directions of the first and third display panels 110-1 and 110-3.

For example, the first, second and third display panels 110-1, 110-2 and 110-3 may include hinges without being limited thereto.

As described above, the first, second and third display panels 110-1, 110-2 and 110-3 may be sequentially stacked in a direction perpendicular to the display screens thereof when folded, and may be arranged in the same plane in at least one of a longitudinal direction and a transversal direction when unfolded.

In this case, when folded, the first, second and third display panels 110-1, 110-2 and 110-3 may be disposed such that the screens of two display panels respectively disposed at outermost positions are directed in opposite directions. When unfolded, the first, second and third display panels 110-1, 110-2 and 110-3 may be disposed such that the screens of the two display panels respectively disposed at the outermost positions are directed in the same direction.

Upon receiving user input, the light shield 100 may fold or unfold the first, second and third display panels 110-1, 110-2 and 110-3, and may then display image information corresponding to a predetermined function on the first, second and third display panels 110-1, 110-2 and 110-3.

For example, when the user input is a request for a lighting function, the light shield 100 may fold the display panels 110 in accordance with the lighting function such that the display panels 110 rotate in predetermined directions through predetermined angles, and may adjust screen brightness of the display panel 110 disposed at an outermost position.

In another example, when the user input is a request for a mirror function, the light shield 100 may fold the display panels 110 in accordance with the mirror function such that the display panels 110 rotate in predetermined directions through predetermined angles, and may display an indoor image acquired from a vehicle camera on the screen of the display panel 110 disposed at an outermost position.

In another example, when the user input is a request for a large-screen display function, the light shield 100 may unfold the display panels 110 in accordance with the large-screen-display function, and may display an image and content information on the screens of the unfolded display panels 110.

In another example, when the user input is a request for a large-screen display function including an information display window, the light shield 100 may unfold all of the display panels 110 in accordance with the large screen-display function including the information display window, and may display additional information on the screens of a part of the unfolded display panels 110 while displaying an image and content information on the screens of the remaining part of the unfolded display panels 100.

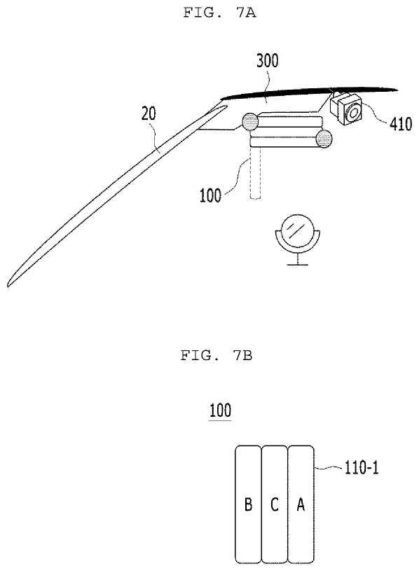

FIG. 6 (which includes FIGS. 6A and 6B) is a view explaining the sun visor apparatus when the sun visor apparatus executes a lighting function.

Upon receiving user input, the controller 300 of the sun visor apparatus may control the driver to fold or unfold the display panels such that the display panels execute a predetermined function of the light shield 100, and may control the light shield 100 to display, on the display panels, image information corresponding to the predetermined function of the light shield 100.

As shown in FIG. 6 when the user input is a request for a lighting function, the controller 300 may control the driver to fold the display panels of the light shield 100 such that the display panels rotate in a predetermined direction through a predetermined angle. In this case, the controller 300 may also control the light shield 100 to adjust screen brightness of the display panel 110-2 disposed at an outermost position of the light shield 100.

In this case, when there is user input generated in association with a lighting angle and a lighting direction of the light shield 100 during control of the driver, the controller 300 may control the driver such that the light shield 100 with the plural display panels folded rotates in the lighting direction according to the user input through the lighting angle according to the user input.

If necessary, when there is no user input generated in association with a lighting angle and a lighting direction of the light shield wo during control of the driver, the controller 300 may control the driver such that the light shield 100 with the plural display panels folded rotates in a predetermined direction through a predetermined angle.

In addition, when there is user input generated in association with a lighting brightness of the light shield 100 during control of the light shield 100, the controller 300 may control the light shield 100 to adjust screen brightness of the display panels in accordance with the user input.

For example, the user input associated with lighting brightness of the light shield 100 may be a screen touch for the display panel disposed at the outermost position without being limited thereto.

If necessary, when there is no user input generated in association with lighting brightness of the light shield 100 during control of the light shield 100, the controller 300 may control the light shield 100 to adjust screen brightness of the display panels in accordance with whether or not vehicle driving is executed and a surrounding environment.

For example, when the vehicle is in a manual driving mode, the controller 300 may control the light shield 100 such that screen brightness of the display panels is lower than reference brightness. On the other hand, when the vehicle is in an autonomous mode or a stop mode, the controller 300 may control the light shield 100 such that screen brightness of the display panels is higher than the reference brightness.

In another example, when ambient illuminance is high, the controller 300 may control the light shield 100 such that screen brightness of the display panels is lower than the reference brightness. On the other hand, when ambient illuminance is low, the controller 300 may control the light shield 100 such that screen brightness of the display panels is higher than the reference brightness.

In this case, the controller 300 may acquire ambient illuminance from an illuminance sensor configured to sense ambient brightness, but may not be limited thereto.

Thus, the sun visor apparatus of embodiment of the present invention may execute an in-vehicle lighting function, using a sun visor display.

That is, embodiments of the present invention may execute a lighting function according to a sun visor angle.

In addition, the sun visor apparatus of embodiments of the present invention has an advantage in that the user may adjust lighting brightness in accordance with whether or not vehicle driving is executed or a surrounding environment (daytime/night) when using the display.

For example, the sun visor apparatus of embodiments of the present invention may be used for reading, etc. in a passenger seat during driving of the vehicle.

Furthermore, the sun visor apparatus of embodiments of the present invention may adjust brightness to first to fourth stages through display touch, but may not be limited thereto.

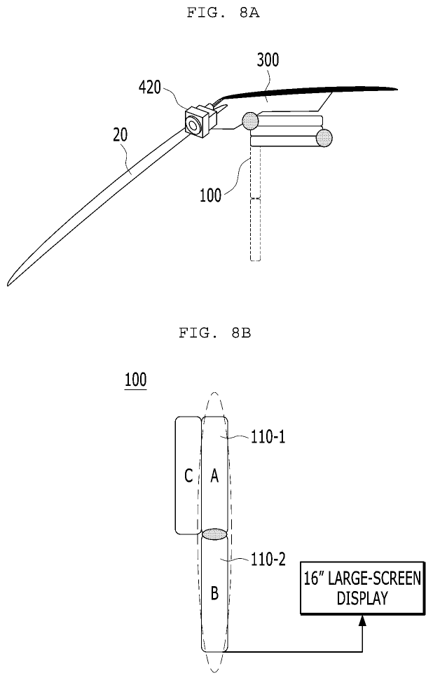

FIG. 7 (which includes FIGS. 7A and 7B) is a view explaining the sun visor apparatus when the sun visor apparatus executes a mirror function.

Upon receiving user input, the controller 300 of the sun visor apparatus may control the driver to fold or unfold the display panels such that the display panels execute a predetermined function of the light shield 100. In this case, the controller 300 may also control the light shield 100 to display, on the display panels, image information corresponding to the predetermined function of the light shield 100.

As shown in FIG. 7, when the user input is a request for a mirror function, the controller 300 may control the driver to fold the display panels of the light shield such that the display panels rotate in a predetermined direction through a predetermined angle. In this case, the controller 300 may also control the light shield 100 to display an indoor image acquired from an in-vehicle camera 410 on the screen of the display panel disposed at the outermost position of the light shield 100.

Thus, the sun visor apparatus of embodiments of the present invention may achieve a mirror function through the in-vehicle camera 410 when the displays are disposed at a predetermined angle in a folded state.

In a conventional sun visor, the mirror thereof may insufficiently perform a desired mirror function in a certain application because an actual mirror size is small. However, embodiments of the present invention may effectively achieve a desired mirror function without any problem because a display monitor having a size of about 14.5 inches is used.

In particular, embodiments of the present invention also provide a flash function using the display panels when the mirror function is executed at night and, as such, may effectively achieve the mirror function.

FIG. 8 (which includes FIGS. 8A and 8B) is a view explaining the sun visor apparatus when the sun visor apparatus executes a large-screen display function.

Upon receiving user input, the controller 300 of the sun visor apparatus may control the driver to fold or unfold the display panels such that the display panels execute a predetermined function of the light shield 100. In this case, the controller 300 may also control the light shield 100 to display, on the display panels, image information corresponding to the predetermined function of the light shield 100.

As shown in FIG. 8, when the user input is a request for a large-screen display function, the controller 300 may control the driver to unfold the display panels of the light shield 100. In this case, the controller 300 may also control the light shield 100 to display an image and content information on the screens of the unfolded display panels.

In this case, when the vehicle is in an autonomous mode, the controller 300 may control the light shield 100 to display an image and content information on the screens of the unfolded display panels.

On the other hand, when the vehicle is not in an autonomous mode, the controller 300 may control the driver to rotate the unfolded display panels in a predetermined direction for sunlight shielding through a predetermined angle for sunlight shielding. The controller 300 may also control the light shield 100 to display outdoor image information acquired from an out-vehicle camera 420 on the screens of the unfolded display panels.

In addition, when there is user input generated in association with a large-screen display size during control of the driver, the controller 300 may control the driver to unfold all or a part of the display panels of the light shield 100 in accordance with the large-screen display size.

Thus, the sun visor apparatus of embodiments of the present invention may change the sun visor display into a large-screen display through unfolding thereof when the vehicle is in an autonomous mode.

For example, it may be possible to change the sun visor display into a large-screen display mode associated with a size of about 16 inches by unfolding the first display panel 110-1, which has a size of about 14.5 inches, and the second display panel 110-2, which has a size of about 14.5 inches.

In this case, an enhancement in utility may be achieved in that the large-screen display having the size of 16 inches may provide various content such as viewing of video and digital multimedia broadcasting (DMB), internet web surfing, and document writing.

In addition, when the vehicle is not in an autonomous mode, the sun visor apparatus of the present invention may be used as a sunlight shield or a travel information system, using the unfolded large-screen display.

For example, the sun visor apparatus of embodiments of the present invention may be used as a travel information system because it may be possible to secure a front view through the out-vehicle camera 420.

Furthermore, the sun visor of embodiments of the present invention may provide a substitutive function such as a front monitor function or a head-up display (HUD) function during driving of the vehicle, using the sun visor display and, as such, there are advantages in terms of space utility and cost reduction because associated items occupying a large physical space may be omitted.

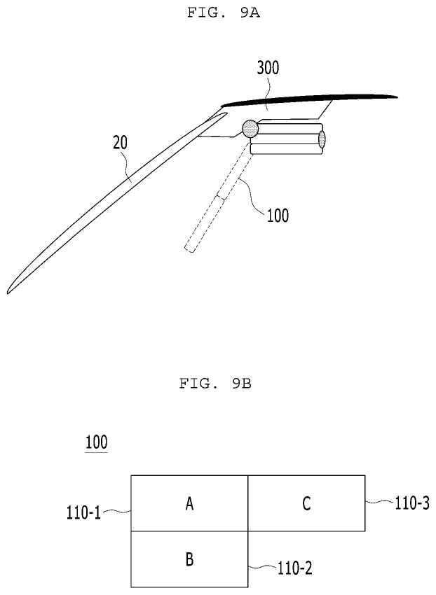

FIG. 9 (which includes FIGS. 9A and 9B) is a view explaining the sun visor apparatus when the sun visor apparatus executes a large-screen display function including an information display window.

Upon receiving user input, the controller 300 of the sun visor apparatus may control the driver to fold or unfold the display panels such that the display panels execute a predetermined function of the light shield 100. In this case, the controller 300 may also control the light shield 100 to display, on the display panels, image information corresponding to the predetermined function of the light shield 100.

As shown in FIG. 9, when the user input is a request for a large-screen display function including an information display window, the controller 300 may control the driver to unfold all of the display panels of the light shield 100. In this case, the controller 300 may also control the light shield 100 to display additional information on the screens of a part of the unfolded display panels while displaying an image and content information on the screens of the remaining part of the unfolded display panels.

In this case, upon displaying additional information on a part of the display panels, the controller 300 may display, on the screens of those display panels, additional information associated with the image and content information displayed on the screens of the remaining part of the display panels.

In addition, when there is user input for selecting an information display window during control of the light shield 100, the controller 300 may control the light shield 100 to display additional information on the screen of a display panel selected as an information display window in accordance with the user input.

The sun visor apparatus of the present invention may have a “┐”-shaped unfolded display shape through unfolding of the foldable displays thereof twice.

In addition, in embodiments of the present invention, it may be possible to select a vertical mode or a horizontal mode in accordance with the unfolded shape of the foldable displays and to utilize the display remaining in accordance with the mode selection as an additional information display window.

That is, the vertical mode or the horizontal mode may be variously selected in accordance with the kind of content utilized by the user.

For example, when the first, second and third display panels 110-1, 110-2 and 110-3 each having a size of about 14.5 inches are unfolded under the condition that the user selects a vertical mode, the first display panel 110-1 and the second display panel 110-2 may be changed to a large-screen display mode having a size of about 16 inches, and the third display panel 110-3 may be changed to an additional information display window mode.

In another example, when the first, second and third display panels 110-1, 110-2 and 110-3 each having a size of about 14.5 inches are unfolded under the condition that the user selects a horizontal mode, the first display panel 110-1 and the third display panel 110-3 may be changed to a large-screen display mode having a size of about 16 inches, and the second display panel 110-2 may be changed to an additional information display window mode.

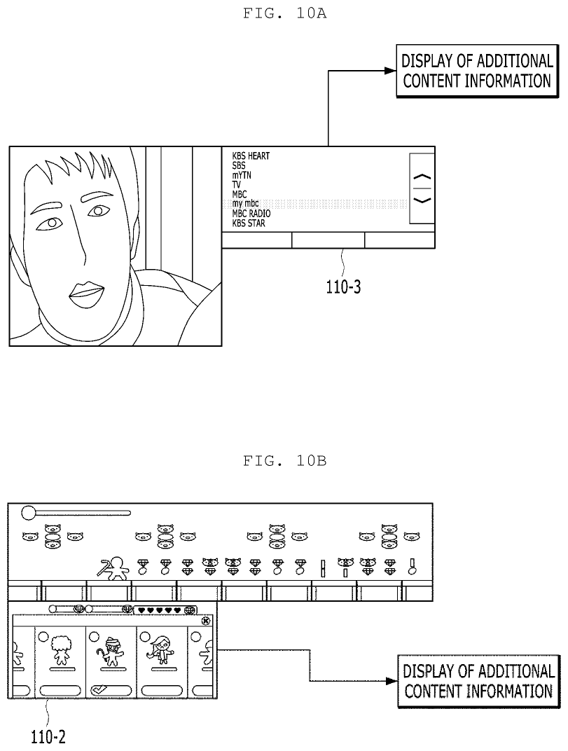

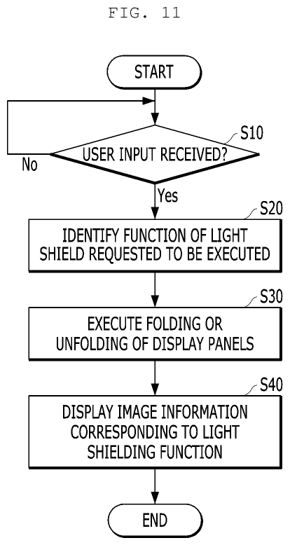

FIGS. 10A and 10B are views illustrating use examples of the sun visor apparatus executing a large-screen display function including an information display window, respectively.

In association with the case in which the first, second and third display panels 110-1, 110-2 and 110-3 each having a size of about 14.5 inches are unfolded, FIG. 10A shows an example of a large-screen display in a vertical mode and a display having an additional information display window, and FIG. 10B shows an example of a large-screen display in a horizontal mode and a display having an additional information display window.

When the first, second and third display panels 110-1, 110-2 and 110-3 each having a size of about 14.5 inches are unfolded under the condition that the user selects the vertical mode, the first display panel 110-1 and the second display panel 110-2 may be utilized as a large-screen display, and the third display panel 110-3 may be utilized as an additional information display window, as shown in FIG. 10A.

On the other hand, when the first, second and third display panels 110-1, 110-2 and 110-3 each having a size of about 14.5 inches are unfolded under the condition that the user selects the horizontal mode, the first display panel 110-1 and the third display panel 110-3 may be utilized as a large-screen display, and the second display panel 110-2 may be utilized as an additional information display window, as shown in FIG. 10B.

FIG. 11 is a flowchart explaining a method for controlling a sun visor apparatus for a vehicle in accordance with an embodiment of the present invention.

FIG. 11 is a view explaining a method for controlling a sun visor apparatus including a light shield including a plurality of display panels, a driver configured to fold or unfold the display panels, and a controller configured to control the light shield and the driver.

As shown in FIG. 11, the controller of the sun visor apparatus may check whether or not user input is received (S10).

When user input is received, the controller may identify a function of the light shield requested to be executed, based on the received user input (S20).

Thereafter, the controller may control the driver to fold or unfold the display panels in accordance with the function of the light shield requested to be executed (S30).

Subsequently, the controller may control the light shield to display, on the display panels, image information associated with the function of the light shield requested to be executed (S40).

In a first embodiment, when the user input is a request for a lighting function, the controller may control the driver to fold the display panels of the light shield such that the display panels rotate in a predetermined direction through a predetermined angle. In this case, the controller may also control the light shield to adjust screen brightness of the display panel disposed at an outermost position of the light shield 100.

In this case, the user input associated with lighting brightness of the light shield may be a screen touch for the display panel disposed at the outermost position without being limited thereto.

If necessary, the controller may control the light shield to adjust screen brightness of the display panels in accordance with whether or not vehicle driving is executed and a surrounding environment.

For example, when the vehicle is in a manual driving mode, the controller may control the light shield such that screen brightness of the display panels is lower than reference brightness. On the other hand, when the vehicle is in an autonomous mode or a stop mode, the controller may control the light shield such that screen brightness of the display panels is higher than the reference brightness.

In another example, when ambient illuminance is high, the controller may control the light shield such that screen brightness of the display panels is lower than the reference brightness. On the other hand, when ambient illuminance is low, the controller may control the light shield such that screen brightness of the display panels is higher than the reference brightness.

In this case, the controller may acquire ambient illuminance from an illuminance sensor configured to sense ambient brightness, but may not be limited thereto.

In a second embodiment, when the user input is a request for a mirror function, the controller may control the driver to fold the display panels of the light shield such that the display panels rotate in a predetermined direction through a predetermined angle. In this case, the controller may also control the light shield to display an indoor image acquired from an in-vehicle camera on the screen of the display panel disposed at an outermost position of the light shield.

In a third embodiment, when the user input is a request for a large-screen display function, the controller may control the driver to unfold the display panels of the light shield. In this case, the controller may also control the light shield to display an image and content information on the screens of the unfolded display panels.

In this case, when the vehicle is in an autonomous mode, the controller may control the light shield to display an image and content information on the screens of the unfolded display panels.

On the other hand, when the vehicle is not in an autonomous mode, the controller may control the driver to rotate the unfolded display panels in a predetermined direction for sunlight shielding through a predetermined angle for sunlight shielding. The controller may also control the light shield to display outdoor image information acquired from an out-vehicle camera on the screens of the unfolded display panels.

In addition, when there is user input generated in association with a large-screen display size during control of the driver, the controller may control the driver to unfold all or a part of the display panels of the light shield in accordance with the large-screen display size.

In a fourth embodiment, when the user input is a request for a large-screen display function including an information display window, the controller may control the driver to unfold all of the display panels of the light shield. In this case, the controller may also control the light shield to display additional information on the screens of a part of the unfolded display panels while displaying an image and content information on the screens of the remaining part of the unfolded display panels.

In this case, upon displaying additional information on a part of the display panels, the controller may display, on the screens of those display panels, additional information associated with the image and content information displayed on the screens of the remaining part of the display panels.

In addition, when there is user input for selecting an information display window during control of the light shield, the controller may control the light shield to display additional information on the screen of a display panel selected as an information display window in accordance with the user input.

Thus, embodiments of the present invention may provide various conveniences to the driver through application of a foldable display capable of realizing a large screen to a sun visor only having a sun visor function.

In addition, embodiments of the present invention may achieve realization of multiple functions such as a lighting function, a mirror function, a large display function, etc. in accordance with a position of the sun visor and whether or not the sun visor is folded.

Furthermore, embodiments of the present invention may provide a large-screen display suitable for a user's needs associated with increased utilization of content according to commercialization of an autonomous vehicle in the future while maximizing utility of packages in a limited indoor compartment of the vehicle.

That is, embodiments of the present invention may provide a sun visor apparatus capable of executing existing functions such as a front monitor function and an HUD function in accordance with functions thereof associated with utilization of in-vehicle packages and, as such, associated items occupying a large physical space may be omitted.

In addition, embodiments of the present invention may secure an increased number of functions and increased utility, as compared to conventional physical sun visors. Furthermore, it may be possible to support various modes in accordance with various display folding shapes given at various angles of the sun visor.

In addition, embodiments of the present invention may provide a sun visor apparatus of a convergence and integration type and, as such, a reduction in cost of the vehicle may be achieved.

A computer-readable recording medium on which a program for executing a method for controlling a sun visor apparatus for a vehicle in accordance with an embodiment of the present invention is written may perform procedures provided in the sun visor apparatus control method.

The embodiments of the present invention as described above may be embodied as computer-readable code, which can be written on a program-stored recording medium. The recording medium that can be read by a computer includes all kinds of recording media on which data that can be read by a computer system is written. Examples of recording media that can be read by a computer may include a hard disk drive (HDD), a solid state drive (SSD), a silicon disk drive (SDD), a read only memory (ROM), a random access memory (RAM), a CD-ROM, a magnetic tape, a floppy disk, an optical data storage, etc.

Therefore, the above detailed description should be understood as exemplary rather than limiting in all aspects. The scope of the present invention should also be interpreted by the claims below. All modifications as would be derived from the equivalent concept intended to be included within the scope of the present invention should also be interpreted as falling within the scope of the invention.

What is claimed is:

1. A sun visor apparatus for a vehicle comprising:
a light shield comprising a plurality of coupled display panels;
a driver configured to drive the display panels of the light shield such that the display panels are folded or unfolded; and
a controller configured to control the light shield and the driver, wherein the controller is configured to receive a user input, to control the driver to fold or unfold the display panels such that the display panels execute a predetermined function of the light shield, and to control the light shield to display, on the display panels, image information corresponding to the predetermined function of the light shield according to the received user input.

2. The sun visor apparatus according to claim 1, wherein the light shield comprises a plurality of fasteners, each disposed at a boundary between adjacent ones of the display panels, the fasteners configured to fasten the adjacent display panels and to rotate the adjacent display panels about the boundary in accordance with a drive signal from the driver.

3. The sun visor apparatus according to claim 2, wherein:
each of the display panels comprises a display screen;
the display panels are sequentially stacked in a direction perpendicular to its display screen when folded; and
the display panels are arranged in one of a longitudinal direction and a transversal direction when unfolded.

4. The sun visor apparatus according to claim 2, wherein:
when the display panels are in a folded configuration, the display panels are arranged such that screens of two display panels, which are disposed at outermost positions, respectively, are directed in opposite directions; and
when the display panels are in an unfolded configuration, the display panels are arranged such that screens of two display panels, which are disposed at outermost positions, respectively, are directed in the same direction.

5. The sun visor apparatus according to claim 2, wherein each of the fasteners comprises a hinge configured to connect and rotate the adjacent display panels corresponding to the fastener.

6. The sun visor apparatus according to claim 1, wherein the light shield is configured to be disposed at an upper portion of a windshield within an interior of the vehicle such that the light shield is configured to rotate toward the windshield in accordance with a drive signal from the driver.

7. The sun visor apparatus according to claim 1, wherein, when the user input is a request for a lighting function, the controller is configured to control the driver to fold the display panels of the light shield such that the display panels rotate in a predetermined direction through a predetermined angle, and is configured to control the light shield to adjust screen brightness of the display panel disposed at an outermost position of the light shield.

8. The sun visor apparatus according to claim 7, wherein, when there is a user input generated in association with lighting brightness of the light shield during control of the light shield, the controller is configured to control the light shield to adjust screen brightness of the display panels in accordance with the user input.

9. The sun visor apparatus according to claim 7, wherein, when there is no user input generated in association with lighting brightness of the light shield during control of the light shield, the controller is configured to control the light shield to adjust screen brightness of the display panels in accordance with whether vehicle driving is executed and in accordance with a surrounding environment.

10. The sun visor apparatus according to claim 1, wherein, when the user input is a request for a mirror function, the controller is configured to control the driver to fold the display panels of the light shield such that the display panels rotate in a predetermined direction through a predetermined angle, and is configured to control the light shield to display an indoor image acquired from a vehicle camera on a screen of the display panel disposed at an outermost position of the light shield.

11. The sun visor apparatus according to claim 1, wherein, when the user input is a request for a large-screen display function, the controller is configured to control the driver to unfold the display panels of the light shield, and is configured to control the light shield to display an image and content information on screens of the unfolded display panels.

12. The sun visor apparatus according to claim 11, wherein:
when the vehicle is configured in an autonomous mode, the controller is configured to control the light shield to display an image and content information on the screens of the unfolded display panels; and
when the vehicle is configured in a non-autonomous mode, the controller is configured to control the driver to rotate the unfolded display panels in a predetermined direction for sunlight shielding through a predetermined angle for sunlight shielding, and is configured to control the light shield to display outdoor image information acquired from a vehicle camera on the screens of the unfolded display panels.

13. The sun visor apparatus according to claim 1, wherein, when the user input is a request for a large-screen display function including an information display window, the controller is configured to control the driver to unfold all of the display panels of the light shield and to control the light shield to display additional information on screens of a part of the unfolded display panels while displaying an image and content information on screens of the remaining part of the unfolded display panels.

14. A method for controlling a sun visor apparatus for a vehicle including a light shield including a plurality of display panels, a driver coupled to the display panels, and a controller coupled to the light shield and the driver, the method comprising:
checking, by the controller, whether a user input is received;
identifying, by the controller, a function of the light shield requested to be executed in accordance with the user input when the user input is received;
causing, by the controller, the driver to fold or unfold the display panels in accordance with the function of the light shield requested to be executed; and
controlling, by the controller, the light shield to display, on the display panels, image information corresponding to the function of the light shield requested to be executed.

15. The method according to claim 14, wherein causing the driver to fold or unfold the display panels and controlling the light shield comprise causing the driver to fold the display panels of the light shield such that the display panels rotate in a predetermined direction through a predetermined angle, while controlling the light shield to adjust screen brightness of the display panel disposed at an outermost position of the light shield, when the user input is a request for a lighting function.

16. The method according to claim 14, wherein causing the driver to fold or unfold the display panels and controlling the light shield comprise causing the driver to fold the display panels of the light shield such that the display panels rotate in a predetermined direction through a predetermined angle, while controlling the light shield to display an indoor image acquired from a vehicle camera on a screen of the display panel disposed at an outermost position of the light shield, when the user input is a request for a mirror function.

17. The method according to claim 14, wherein causing the driver to fold or unfold the display panels and controlling the light shield comprise causing the driver to unfold the display panels of the light shield, while controlling the light shield to display an image and content information on screens of the unfolded display panels, when the user input is a request for a large-screen display function.

18. The method according to claim 14, wherein causing the driver to fold or unfold the display panels and controlling the light shield comprise causing the driver to unfold all of the display panels of the light shield, while controlling the light shield to display additional information on screens of a part of the unfolded display panels while displaying an image and content information on screens of the remaining part of the unfolded display panels, when the user input is a request for a large-screen display function including an information display window.

19. A non-transitory computer-readable recording medium having recorded thereon a program for executing the method of claim 14.

20. A vehicle comprising:
an input device; and
a sun visor apparatus comprising a plurality of display panels, wherein the sun visor apparatus is configured to fold or unfold the display panels in accordance with a user input from the input device, to execute a predetermined function, wherein the sun visor apparatus further comprises:
a light shield, at which the plurality of display panels is disposed in a coupled state,
a driver configured to drive the display panels of the light shield such that the display panels are folded or unfolded, and
a controller configured to control the light shield and the driver, the controller configured to cause the driver to fold or unfold the display panels such that the display panels execute a predetermined function of the light shield, and configured to control the light shield to display, on the display panels, image information corresponding to the predetermined function of the light shield, upon receiving the user input.
